(19) United States
(12) Patent Application Publication
(10) Pub. No.: US 2016/0281923 A1
(43) Pub. Date: Sep. 29, 2016

(54) Lubricating Duct Feeder

(71) Applicant: Richard Van Weezel, Burleson, TX (US)

(72) Inventor: Richard Van Weezel, Burleson, TX (US)

(21) Appl. No.: 15/181,782

(22) Filed: Jun. 14, 2016

(51) Int. Cl. F16N 21/04; F16N 27/02; F16N 27/00

(52) U.S. Cl. CPC F16N 21/04; F16N 27/005; F16N 27/02; F16N 2210/34

(57) ABSTRACT

A lubricating feeder apparatus comprises a feeder conduit section, a liquid conduit section, and a liquid regulating device. The feeder apparatus is used for feeding conduit to an underground conduit system having a plurality of conduit system sections connected to form a continuous underground duct. The feeder conduit section defines a primary duct, and includes a receiving end and a feeding end. The liquid conduit section is attached to the feeder conduit section. The liquid conduit section has a liquid receiving end and a liquid dispensing end. The liquid dispensing end is connected to the feeder conduit section such that a secondary duct defined by the liquid conduit section is in fluid connection with the primary duct. The liquid regulating device is disposed within the secondary duct for regulating the flow rate of liquid therethrough.

### TECHNICAL FIELD

The system of the present application relates to an apparatus and method for feeding conductors into a conduit. In particular, the system of the present application relates to a system and method for providing lubrication to conductors as they are fed into a conduit.

### BRIEF DESCRIPTION OF THE DRAWINGS

The novel features believed characteristic of the system of the present application are set forth in the appended claims. However, the system itself, as well as a preferred mode of use, and further objectives and advantages thereof, will best be understood by reference to the following detailed description when read in conjunction with the accompanying drawings, in which the leftmost significant digit(s) in the reference numerals denote(s) the first figure in which the respective reference numerals appear, wherein:

FIG. 1 shows a side view of a lubricating feeder apparatus according to the present disclosure;

FIG. 2 shows a cross-sectional view of the feeder apparatus shown in FIG. 1;

FIGS. 3 and 4 show enlarged views of embodiments of the portion of FIG. 2 designated 3,4;

FIG. 5 shows a schematic diagram of an example of the feeder apparatus shown in FIGS. 1 and 2 in use;

FIG. 6 shows a cross-sectional view of the feeder apparatus shown in FIGS. 1 and 2 in use;

FIG. 7 shows a perspective view of an embodiment of a support structure shown in FIG. 5; and

FIGS. 8 and 9 show side views of respective alternative embodiments of the lubricating feeder apparatus according to the present disclosure.

While the system of the present application is susceptible to various modifications and alternative forms, specific embodiments thereof have been shown by way of example in the drawings and are herein described in detail. It should be understood, however, that the description herein of specific embodiments is not intended to limit the method to the particular forms disclosed, but on the contrary, the intention is to cover all modifications, equivalents, and alternatives falling within the spirit and scope of the application as defined by the appended claims.

### DESCRIPTION OF THE PREFERRED EMBODIMENT

Illustrative embodiments of the system of the present application are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms such as “above,” “below,” “upper,” “lower,” or other like terms to describe a spatial relationship between various components or to describe the spatial orientation of aspects of such components should be understood to describe a relative relationship between the components or a spatial orientation of aspects of such components, respectively, as the device described herein may be oriented in any desired direction.

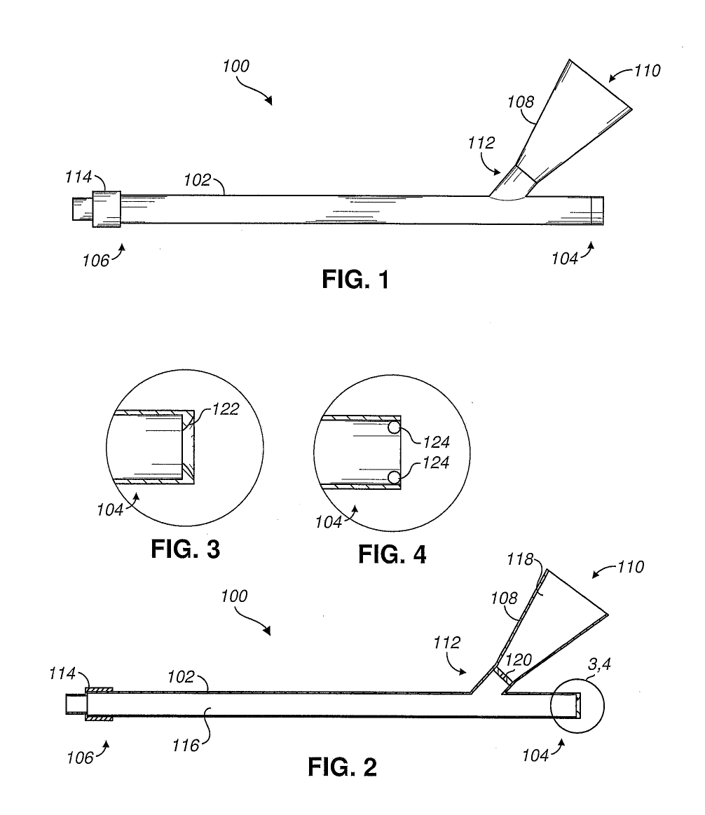

FIG. 1 shows a side view of a lubricating feeder apparatus 100 according to the present disclosure. The lubricating feeder apparatus 100 is particularly well-suited for use with an underground conduit system having a plurality of conduit system sections connected to form a continuous underground duct. Often when a number of conduits are extended through an underground duct, the collective size of the conduits makes it difficult to extend them through the underground conduit system because the internal diameter of the duct may not be much larger than the outside diameter of the group of conduits. In some cases, friction between the inner surfaces of the duct and the outer surfaces of the conduits can be great enough that the amount of force needed to pull the conduits through the duct can result in damage to one or more of the conduits. The lubricating feeder apparatus 100 provides a convenient way to both channel multiple conduits into a duct and to introduce a lubricating agent onto the conduits as they are being fed into the underground duct. The lubricating agent, which can be, for example, any desired oily or soapy substance, will reduce friction between the conduits and the inner surfaces of the duct, thereby reducing the amount of force needed to pull the conduits through the duct and also reduce the risk of damage to the conduits.

The lubricating feeder apparatus 100 includes a feeder conduit section 102 having a receiving end 104 and a feeding end 106. The lubricating feeder apparatus 100 also includes a liquid conduit section 108 having a liquid-receiving end 110 and a liquid-dispensing end 112.

In some embodiments, such as the one shown in FIG. 1, the lubricating feeder apparatus 100 can optionally include an interchangeable and removable size adapter 114. The removable size adapter 114 can be one of a plurality of such adapters that can be attached to the feeding end 106 of the feeder conduit section 102 to match the outside diameter of the feeding end 106 to the internal diameter of an underground conduit system into which the feeder apparatus 100 is feeding one or more conduits. In the embodiment shown, the size adapter 114 is a reducer adapter, meaning that it can be used to attach the feeder apparatus 100 to a conduit system having an internal diameter that is smaller than the outside diameter of the feeder apparatus 100. Alternatively, a size adapter 114 can be an increaser adapter for matching the outside diameter of the feeder apparatus 100 to a conduit system having an internal diameter that is greater than the outside diameter of the feeder apparatus 100.

The feeder apparatus 100 can be a rigid device that is formed of rigid materials such as rigid polyvinyl chloride (PVC), plastic, metal, or composite material. Alternatively, the feeder apparatus 100 can be a semi-rigid or flexible device that is formed of semi-rigid or flexible materials, such as flexible PVC, flexible vinyl, or rubber. In some embodiments, the feeder apparatus 100 can include flexible and rigid components. For example, in some embodiments, the feeder conduit section 102 can be flexible, for example formed of rubber or flexible vinyl, while the liquid conduit section 108 is rigid, e.g., formed of PVC or plastic. Still further alternative arrangements are possible by combining various combinations of flexible and rigid components to form the feeder apparatus 100.

FIG. 2 shows a cross-sectional view of the feeder apparatus 100. The feeder conduit section 102 defines a primary duct 116 that extends between the receiving end 104 and the feeding end 106 of the feeder conduit section 102. The liquid conduit section 108 defines a secondary duct 118 that extends between the liquid receiving end 110 and the liquid dispensing end 112 of the liquid conduit section 108. In some embodiments, such as the one shown in FIG. 2, the liquid receiving end 110 of the liquid conduit section 108 has an internal diameter that is greater than that of the liquid dispensing end 112 of the liquid conduit section 108. The secondary duct 118 is in fluid connection with the primary duct 116. As discussed in greater detail below, the primary duct 116 can serve as a passage for directing one or more conduits into an underground conduit system. The secondary duct 118 can serve as a passage for directing a lubricant onto the conduits as they pass through the primary duct 116.

In some embodiments, a liquid regulating device 120 can be disposed within the secondary duct 118 for regulating the amount of liquid that can flow from the liquid receiving end 110 to the liquid dispensing end 112 of the liquid conduit section 108. In the embodiment shown in FIG. 2, the liquid regulating device 120 is a baffle, such as a plate having one or more holes therethrough. However, alternative embodiments of the liquid regulating device 120 can be used. For example, as discussed below, the liquid regulating device 120 can comprise an adjustable valve in place of, or in conjunction with, a baffle. The liquid regulating device 120 allows for limiting or controlling the amount of liquid that is directed onto conduits as they pass through the primary duct 116.

The receiving end 104 of the feeder conduit section 102 can be configured to prevent chafing of conduits as they enter the primary duct 116. For example, in some embodiments, such as shown in FIG. 3, the inner edge of the receiving end 104 of the feeder conduit section 102 can have a beveled edge 122. The beveled edge 122 can have any of a variety of cross-sectional shapes, for example resulting in a rounded or chamfered edge. Alternatively, as shown in FIG. 4, the inner edge of the receiving end 104 of the feeder conduit section 102 can have one or more rollers 124 or bearings attached thereto that are free to roll as conduit is fed into the primary duct 116.

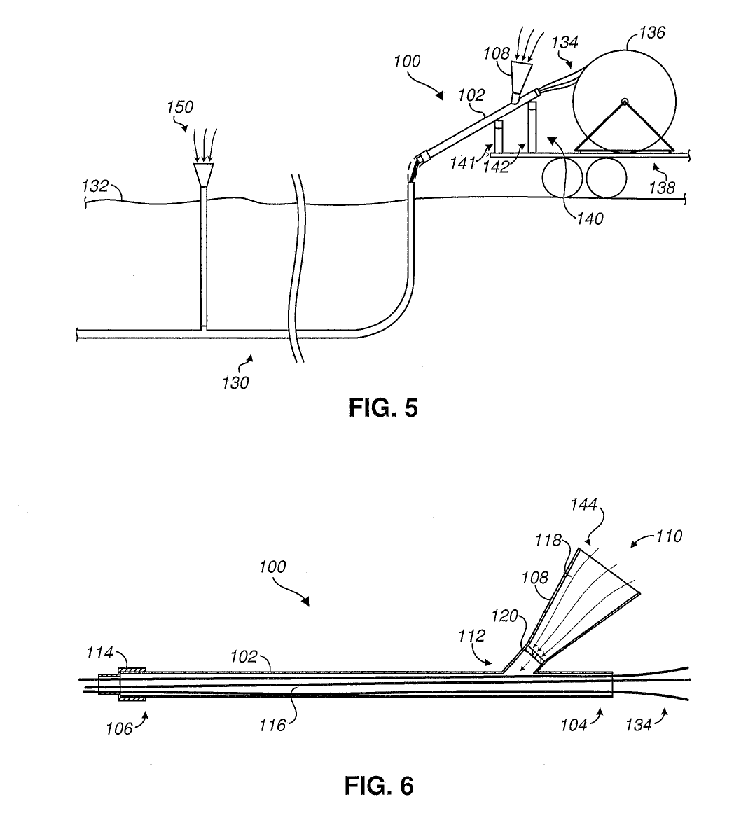

FIG. 5 shows a schematic diagram of an example of the feeder apparatus 100 in use. As discussed above, the lubricating feeder apparatus 100 is particularly well-suited for use with an underground conduit system. FIG. 5 shows a portion of an underground conduit system 130. The underground conduit system 130 provides a duct through which one or more conduits can extend below ground level 132. There are a wide variety of such systems known by those in the art that are in widespread use for burying various types of conduits, such as power lines, phone lines, networking cables, and fiber optic cables.

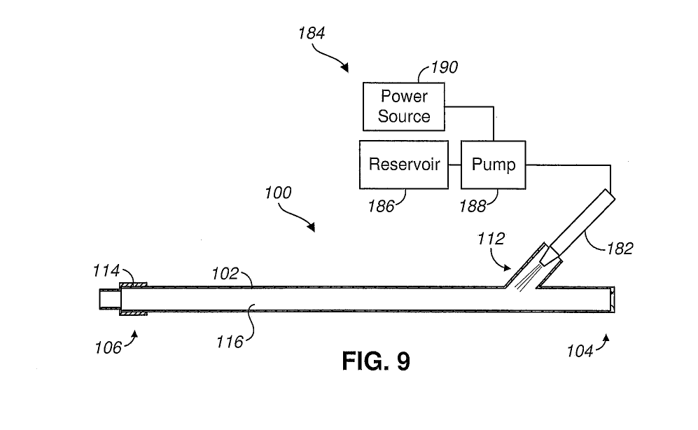

FIG. 6 shows a cross-sectional view of the feeder apparatus 100 in use. As shown in FIGS. 5 and 6, a plurality of conduits 134 can be fed from one or more conduit spools 136, through the feeder conduit section 102 of the feeder apparatus 100, then into and through the underground conduit system 130. The one or more spools 136 are supported by a mobile platform 138, such as a vehicle, a trailer, or a cart. Also, the feeder apparatus 100 is supported by a support structure 140, which in this embodiment comprises a first support assembly 141 and a second support assembly 142. As the conduits 134 are fed through the feeder conduit section 102, a lubricant (represented by arrows 144) is provided into the liquid receiving end 110 of the liquid conduit section 108. The flow rate and volume of the lubricant 144 can be reduced by the liquid regulating device 120 to prevent over-saturation of the conduits 134. The liquid lubricant can be added to the liquid receiving end 110 by a person pouring it in or by an automated system, such as the one described below in connection with FIG. 9.

In some embodiments, additional lubricant can be added to the conduits 134 as they pass through the underground conduit system 134 with the use of one or more intermediate lubricating apparatus 150. The intermediate lubricating apparatus 150 defines an intermediate lubricating duct that extends between an above-ground liquid-receiving port 152 and the underground duct of the underground conduit system 130. Thus, lubricant added to the liquid-receiving port 152 will flow into the underground conduit system 130 and onto the conduits 134 therein. The use of one or more intermediate lubricating apparatus 150 can be desirable where the underground conduit system 130 is long enough for lubricant 144 to be worn from the conduits 134 before the conduits 134 have passed all the way through the underground conduit system 130.

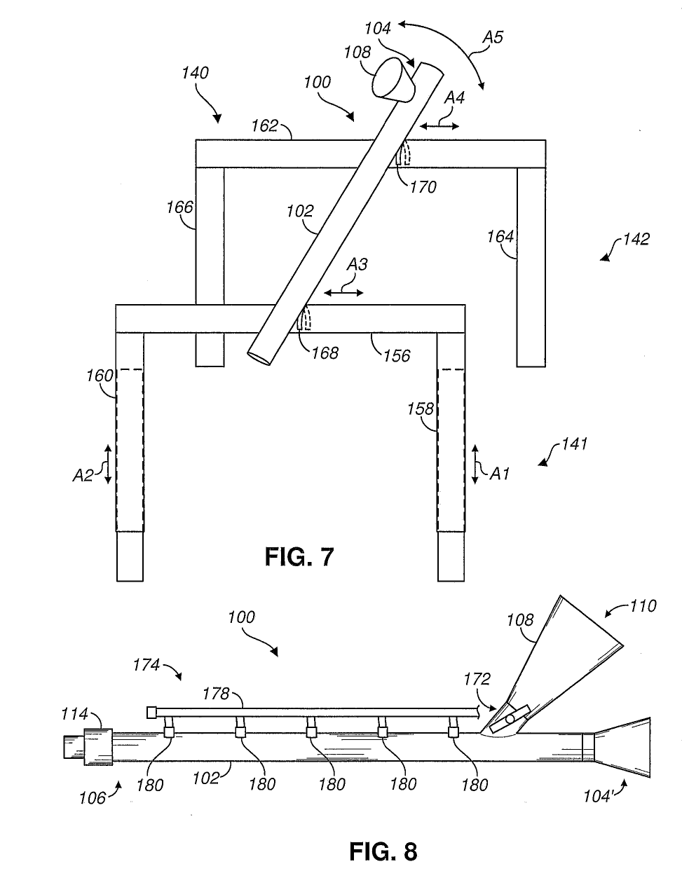

FIG. 7 shows a perspective view of an embodiment of a support structure 140. The support structure 140 is provided to hold the feeder apparatus 100 between the spools 136 and the underground conduit system 130. However, as conduits 134 are being fed from the spool 136, the position of the conduit between the spool 136 and the receiving end 104 of the feeder apparatus 100 will tend to move both vertically and horizontally relative to both the spool 136 and to the feeder apparatus 100. This movement of the conduit 134 results from the way that the conduit 134 is wound about the spool 136. Therefore, it is desirable for the receiving end 104 of the feeder apparatus 100 to be free to move with the incoming conduits 134 while the feeder apparatus 100 is held in position between the spools 136 and the underground conduit system 130.

The support structure 140 provides at least two degrees of freedom of movement for the receiving end 104 of the feeder apparatus 100 while holding the feeder apparatus 100 in position between the spools 136 and the underground conduit system 130. The support structure 140 includes a first support assembly 141 and a second support assembly 142. The first support assembly 141 includes a cross member 156 supported by a first leg member 158 and a second leg member 160. The first and second leg members 158 and 160 are telescoping elements, meaning that the leg members 158 and 160 are free to extend and retract length-wise in the directions indicated by arrows A1 and A2, respectively. The second support assembly 142 includes a cross member 162 supported by a first leg member 164 and a second leg member 166. The first and second leg members 164 and 166 can differ from the leg members 158 and 160 in that the leg members 164 and 166 are fixed in length. The lubricating feeder apparatus 100 is supported by the cross members 156 and 162. The lubricating feeder apparatus 100 is preferably attached to the cross members 156 and 162 by connectors 168 and 170, respectively. The connectors 168 and 170 preferably are configured such that they are fixed to the feeder conduit section 102 and are slidably attached to the cross members 156 and 162. The connectors 168 and 170 can include clamps, rings, bands, straps, or other hardware that allow the feeder apparatus 100 to freely slide in the directions indicated by arrows A3 and A4 relative to the cross members 156 and 162. Also, as a result of the telescoping legs 158 and 160, the feeder apparatus 100 can pivot on the cross member 162 of the second support assembly 142, allowing the receiving end 104 to be freely rotatable about a longitudinal axis of the cross member 162, thereby moving freely in a vertical direction as indicated by arrow A5.

Alternative embodiments of the feeder apparatus 100 are shown in FIGS. 8 and 9. It should be appreciated that still further embodiments are possible by combining elements of the embodiments of the feeder apparatus shown in FIGS. 1, 8, and 9.

FIG. 8 shows an embodiment of the feeder apparatus 100 that differs from the embodiment shown in FIG. 1 in that the feeder apparatus 100 shown in FIG. 8 includes a user-adjustable valve 172, a lubricant misting system 174, and a flared receiving end 104′.

The user-adjustable valve 172 serves as a user-adjustable embodiment of the liquid regulating device 120 described above. However, unlike the baffle shown in FIG. 2, which has fixed regulating properties, the valve 172 allows a person to adjust the amount of liquid that flows between the liquid receiving end 110 and the liquid dispensing end 112 of the liquid conduit section 108. The valve 172 can be any of a number of liquid valves known in the art that can be used to adjust the flow rate of liquid therethrough through the use of a rotatable handle or other user-controllable implement.

The lubricant misting system 174 comprises a hose 178 connected to one or more misting nozzles 180. The misting nozzles 180 are connected to the feeder conduit section 102 for spraying lubricant into the primary duct 116 of the feeder apparatus 100. Thus, as lubricant is fed into the hose 178, for example from a remote reservoir or any kind of lubricant dispenser, the lubricant travels through the hose 178 to the nozzles 180, which in turn dispense the lubricant onto the conduits 134 traveling through the primary duct 116. While the embodiment shown in FIG. 8 allows lubricant to be fed into the primary duct 116 of the feeder apparatus 100 through both the liquid conduit section 108 and the lubricant misting system 174, alternative embodiments can lack a liquid conduit section 108 but include the lubricant misting system 174.

The flared receiving end 104′ represents an alternative embodiment of the receiving end 104 of the feeder conduit section 102 shown in FIGS. 1-7. The flared receiving end 104′ differs from the receiving end 104 of the first embodiment in that the flared receiving end 104′ results in a feeder conduit section where the receiving end 104′ of the feeder conduit section 102 has an internal diameter that is greater than that of the feeding end 106. More specifically, the flared receiving end 104′ has a relatively larger opening that narrows toward the primary duct 116. The flared receiving end 104′ provides an opening that helps gather and consolidate multiple conduits 134 that are entering the feeder apparatus 100 from multiple locations and angles.

FIG. 9 shows an embodiment of the feeder apparatus 100 that differs from the embodiment shown in FIG. 1 in that the feeder apparatus 100 shown in FIG. 9 includes a spray nozzle 182 that serves as a user-adjustable embodiment of the liquid regulating device 120 described above. However, unlike the baffle shown in FIG. 2, which has fixed regulating properties, the spray nozzle 182 allows a person to adjust the amount of liquid that flows between the liquid receiving end 110 and the liquid dispensing end 112 of the liquid conduit section 108. The spray nozzle 182 can be any of a number of spray nozzles known in the art that can be operated to spray a liquid, particularly those where the volume of liquid being sprayed can be controlled by the operator, for example where the operator squeezes a trigger handle or the like and where the spray volume depends on the degree to which the user squeezes the trigger handle.

Also, as shown in FIG. 9, the liquid lubricant can be provided by a lubricant-dispensing system 184. The lubricant-dispensing system 184 comprises a reservoir 186, a pump 188, and a power source 190. The reservoir 186 can be a canister or container that stores some volume of lubricant to be dispensed into the feeder apparatus 100. The pump 188 can be any of a number of know pumps useful for driving liquid from one place to another. The pump 188 is in fluid communication with the reservoir 186. The pump 188 is electrically connected to the power source 190. The power source 190 can be any of a variety of known electrical power sources rated suitably for driving the pump 188, for example a portable generator or a fixed electrical power source. When the lubricant-dispensing system 184 is activated, the power source 190 provides power to the pump 188, which in turn pumps lubricant from the reservoir 186 to the spray nozzle 182. Alternatively, the lubricant-dispensing system 184 can be used with the embodiments shown in FIGS. 1-8 where the pump 188 instead provides the lubricant to the liquid receiving end 110 of the liquid conduit section 108.

The particular embodiments disclosed above are illustrative only, as the application may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the application. Accordingly, the protection sought herein is as set forth in the claims below. It is apparent that a system with significant advantages has been described and illustrated. Although the system of the present application is shown in a limited number of forms, it is not limited to just these forms, but is amenable to various changes and modifications without departing from the spirit thereof.

What is claimed is:

1. A lubricating feeder apparatus for an underground conduit system having a plurality of conduit system sections connected to form a continuous underground duct, the apparatus comprising:
a feeder conduit section defining a primary duct, the feeder conduit section having a receiving end and a feeding end;
a liquid conduit section attached to the feeder conduit section, the liquid conduit section having a liquid receiving end and a liquid dispensing end, the liquid dispensing end being connected to the feeder conduit section, the liquid conduit section defining a secondary duct that is in fluid connection with the primary duct; and
a liquid regulating device disposed within the secondary duct for regulating an amount of liquid that can flow from the liquid receiving end to the liquid dispensing end of the liquid conduit section.

2. The apparatus according to claim 1, wherein the liquid regulating device comprises at least one of a baffle, a valve, and a spray nozzle.

3. The apparatus according to claim 1, wherein the liquid receiving end of the liquid conduit section has an internal diameter that is greater than that of the liquid dispensing end of the liquid conduit section.

4. The apparatus according to claim 1, further comprising a plurality of nozzles connected to the feeder conduit section for spraying lubricant into the primary duct.

5. The apparatus according to claim 1, wherein the receiving end of the feeder conduit has an internal diameter that is greater than that of the feeding end.

6. The apparatus according to claim 1, wherein the receiving end of the feeder conduit comprises a beveled edge.

7. The apparatus according to claim 1, wherein the receiving end of the feeder conduit comprises a plurality of rollers.

8. An underground conduit system having a plurality of conduit system sections connected to form a continuous underground duct between a first end and a second end of the conduit system, the system comprising:
a lubricating feeder apparatus comprising:
a feeder conduit section defining a primary duct, the feeder conduit section having a receiving end and a feeding end, the feeding end being connected to the first end of the conduit system;
a liquid conduit section attached to the feeder conduit section, the liquid conduit section having a liquid receiving end and a liquid dispensing end, the liquid dispensing end being connected to the feeder conduit section, the liquid conduit section defining a secondary duct that is in fluid connection with the primary duct; and
a liquid regulating device disposed within the secondary duct for regulating an amount of liquid that can flow from the liquid receiving end to the liquid dispensing end of the liquid conduit section; and
an intermediate lubricating apparatus defining an intermediate lubricating duct that extends between an above-ground liquid-receiving port and the underground duct of the underground conduit system.

9. The system according to claim 8, wherein the liquid regulating device comprises at least one of a baffle, a valve, and a spray nozzle.

10. The system according to claim 8, wherein the liquid receiving end of the liquid conduit section has an internal diameter that is greater than that of the liquid dispensing end of the liquid conduit section.

11. The system according to claim 8, further comprising a plurality of nozzles connected to the feeder conduit section for spraying lubricant into the primary duct.

12. The system according to claim 8, wherein the receiving end of the feeder conduit has an internal diameter that is greater than that of the feeding end.

13. The system according to claim 8, wherein the receiving end of the feeder conduit comprises a beveled edge.

14. The system according to claim 8, wherein the receiving end of the feeder conduit comprises a plurality of rollers.

15. A mobile lubricating feeder system comprising:
a mobile platform;
a first support assembly supported by the mobile platform;
a second support assembly supported by the mobile platform; and
a lubricating feeder apparatus supported by the first and second support assemblies, the lubricating feeder apparatus comprising:
a feeder conduit section defining a primary duct, the feeder conduit section having a receiving end and a feeding end;
a liquid conduit section attached to the feeder conduit section, the liquid conduit section having a liquid receiving end and a liquid dispensing end, the liquid dispensing end being connected to the feeder conduit section, the liquid receiving end having an internal diameter that is greater than that of the liquid dispensing end, the liquid conduit section defining a secondary duct that is in fluid connection with the primary duct; and
a liquid regulating device disposed within the secondary duct for regulating an amount of liquid that can flow from the liquid receiving end to the liquid dispensing end of the liquid conduit section.

16. The system according to claim 15, wherein the first support assembly includes a cross member supported by first and second leg members.

17. The system according to claim 16, wherein the first and second leg members are telescoping leg members.

18. The system according to claim 16, wherein the lubricating feeder apparatus is supported by the cross member and is freely slidable between first and second ends of the cross member.

19. The system according to claim 16, wherein the lubricating feeder apparatus is supported by the cross member and is freely rotatable about a longitudinal axis of the cross member.

20. The system according to claim 15, wherein the mobile platform includes at least one of a vehicle, a trailer, and a cart.
